(19) United States
(12) Patent Application Publication
(10) Pub. No.: US 2005/0216101 A1
(43) Pub. Date: Sep. 29, 2005

(54) Analog input slave and monitoring system

(75) Inventor: Hiroshi Shimizu, Mishima-shi (JP)

Correspondence Address: FOLEY AND LARDNER;SUITE 500, 3000 K STREET NW, WASHINGTON, DC, 20007, US

(73) Assignee: Omron Corporation

(21) Appl. No.: 11/079,013

(22) Filed: Mar. 14, 2005

(30) Foreign Application Priority Data
Mar. 15, 2004 (JP) P2004-073522

(51) Int. Cl. G05B 19/18; G05B 11/01; G06F 15/00; G04F 10/00; G01D 1/00

(52) U.S. Cl. 700/20; 700/3; 702/176; 702/127

(57) ABSTRACT

An analog input slave having an analog input portion and a network connecting portion, includes: i) a total time calculating device for seeking a total time when data acquired from the analog input portion is within a set range; ii) a comparing device for comparing the total time sought by the total time calculating device with a threshold; and iii) a sending device for sending from the network connecting portion a comparison result by the comparing device.

### BACKGROUND OF THE INVENTION

1. Field of the Invention

The present invention relates to an analog input slave and a monitoring system.

2. Description of the Related Art

As well known, in a factory automation (hereinafter referred to as “FA”), an I/O device and other apparatus-and-device are connected to a programmable controller (hereinafter referred to as “PLC”) directly or by way of a network. The PLC acquires, as an input data, information from an input device such as a switch and a sensor each of which is a type of the I/O device. According to a user program built in advance, the PLC uses the thus acquired input data and implements an arithmetic operation to thereby determine control toward an output device which is a type of the I/O device. With this, the PLC outputs control data corresponding to the control to an output device such as a valve, an actuator and a motor, to thereby control the entire FA system.

More specifically, in terms of controlling by a CPU unit of the PLC, a signal inputted from an input device connected to an input unit is taken into an I/O memory of the CPU unit (IN refresh), a logic operation is carried out (operation is implemented) based on a user program which is built in a ladder language registered in advance, a result of implementing the operation is written in the I/O memory, to be thereafter sent out to an output unit (OUT refresh), thereby, the output unit carries out control of driving and stopping the output device, thereafter, carrying out what-is-called a peripheral process which implements a communication by way of a communication network.

In the above manner, the PLC cyclically and repeatedly processes the IN refresh, the operation, the OUT refresh, and the peripheral process.

In addition, the input device and the output device are directly connected to the input unit and the output unit which constitute the PLC, or connected by way of the network. An example of the connection by way of the network includes an implementation with a master-to-slave communication. In this case, i) the master unit (master) which constitutes the PLC and ii) the slaves are to be connected to the field network, enabling a communication between the master and the slave by way of the field network. Connecting the input device and the output device to this slave may transmit, for example, an input signal sensed with the input device to the master by way of the slave and the field network. Then, the input signal is transmitted from the master to the CPU unit by way of a PLC bus.

On the PLC side, based on the acquired input information, the user program is implemented, a result of implementing the user program is transmitted, as a control instruction signal, to the slave via the master unit and the network, to thereby send from the slave a control instruction to the output device (relay, valve, actuator and the like) which is to be operated.

Moreover, there are various types of input devices, examples thereof including a limit switch and the like outputting ON/OFF data as input information, and a temperature sensor and the like outputting analog data as input information.

In addition, sending-receiving of the I/O information such as the input signal and output signal of the device connected to the slave is carried out in preset communication timing between the slave and the master unit. The above sending-receiving of the I/O information is not synchronous with the PLC's cyclic processing, and is implemented in another timing. The PLC's CPU unit and the PLC's master unit are connected via a bus. Of the CPU unit's cyclic processes, the IN refresh and OUT refresh (I/O refresh), and the peripheral service processing carry out the sending-receiving of the data between the CPU unit and the master unit. With this, the PLC's CPU unit connects to the slave the input device and the output device which are remotely located, to thereby carry out the sending-receiving of the data by way of the network.

By the way, with a recent FA's network system, in addition to controlling and monitoring of the current control, a proper monitoring of non-controlled information such as information about system state is more and more demanded. Specifically, when the apparatus-and-device constituting the FA system fail in the system's operation, the system will stop and the works and the like manufactured in the operation may become defective. Therefore, a demand is arising for sensing the failure as soon as possible so as to replace the apparatus-and-device before they cause failure.

Japanese Patent Unexamined Publication No. 2003-295914 discloses a conventional technology solving the above demand, although Japanese Patent Unexamined Publication No. 2003-295914 does not disclose a slave (analog input slave) handling the analog data which is an object of present invention. A slave in Japanese Patent Unexamined Publication No. 2003-295914 has a function of accurately measuring an output device's operation time which is maintenance information. Seeking the operation time on the slave side can decrease load on the PLC side. Specifically in terms of structure, for monitoring an operation time of an actuator such as a cylinder, an internal timer is used for measuring the time from the following i) to ii): i) an OUT terminal connected with the actuator connected is turned ON and ii) an IN terminal connected with a sensor for sensing that the actuator comes to an operation completion position is turned ON. With the above, the obtained time becomes an operation time of the output device, therefore, the operation time is compared with a setting value, to thereby also determine whether or not the actuator is normal.

The input device and the output device which are connected to the slave in Japanese Patent Unexamined Publication No. 2003-295914 are controlled by the ON/OFF information. Therefore, the slave merely brings about a function of measuring the time between change points of two contact points (rise/fall).

The above conventional system according to the related art, however, has the following problem. Specifically, the invention under the Japanese Patent Unexamined Publication No. 2003-295914 is, as a matter of course, not applicable to a slave where an input data corresponds to an analog data. In other words, for example, conventionally, in a case where temperature of a controlled apparatus (control object) which is a temperature sensor is measured in an analog measurement area of FA, exceeding a certain temperature, as the case may be, progresses deterioration level of the controlled apparatus (control object) which is the temperature sensor. This is not limited to the temperature. For example, repeated operations proportional to an analog quantity, as the case may be, progresses deterioration level of the apparatus.

With the above deterioration level progressed to such an extent as to go beyond a certain level, the sensor and the apparatus are in failure. Therefore, it is preferable to check the deterioration in advance, and it is also preferable that the sensor and the apparatus have been replaced before the failure. By the way, for knowing the deterioration level in advance, usually, analog data collected from the slave is to be operated for process by the PLC (CPU unit) which is disposed on the upper side. From the processing result, the apparatus's deterioration state and maintenance timing are to be sought. For implementing the above process, an analysis program for implementing the applicable process is to be developed for the user program and added to the user program. Processing on the PLC side, however, increases the load of the PLC's program implementation, which is not preferable. In addition, the user program is a language that is proper for the controlling, not well at setting and the like of parameter such as temperature regulation parameter.

Moreover, there is a problem that the load of communication with the slave is increased. It is necessary to constantly obtain updated information from the slave. Therefore, in the communication between the PLC's master and the slave, communicating the basic data on the maintenance information is necessary in addition to the control information as the I/O data. With this, communication information quantity is increased, thus increasing communication time, thereby elongating communication cycle between the master and the slave. In addition, the upper-side program in the FA control has controlling program which is a main program and is important, therefore increasing a risk of mixing programs such as comparative analysis program and information control program. Especially, adding afterward the data analysis program to the controlling program which is already in operation may cause harmful effect on the controlling program. Therefore, determination whether to actually add or not is of difficulty.

For controlling the control object's temperature, a temperature regulator is to be installed otherwise, and a thermocouple is to be connected as an analog (temperature) input to the control object, for example, i) for ON/OFF output for controlling a heater heating the control object and ii) for feedback, to thereby implement the control such that the control object has a certain temperature. In this case, utilizing the analog (temperature) input of the temperature regulator may possibly allow the temperature regulator to implement the above process. As a matter of course, however, the above implementation can be utilized only when the temperature control is carried out with the temperature regulator. In general, when not only the control object's temperature but also various physical quantity data are the comparative analysis object, this structure cannot be utilized.

Moreover, like the above PLC, in addition to the temperature control of the control object, a load for implementing programs such as a comparative analysis program and a information processing program is added to the temperature regulator, elongating control interval of the temperature regulation, which is not preferable.

### SUMMARY OF THE INVENTION

It is an object of the present invention to provide a slave (analog input slave) and a monitoring system which are capable of suppressing a load on a PLC and the like while sensing on the slave side a replacement timing for replacing i) a sensor and other apparatus-and-device connected to the slave and ii) device-apparatus {control object (monitoring object)} controlled by the sensor and the like, thereby decreasing the load on the upper PLC and the like.

According to a first aspect of the present invention, there is provided an analog input slave having an analog input portion and a network connecting portion, comprising: i) a total time calculating device for seeking a total time when data acquired from the analog input portion is within a set range; ii) a comparing device for comparing the total time sought by the total time calculating device with a threshold; and iii) a sending device for sending from the network connecting portion a comparison result by the comparing device.

According to a second aspect of the present invention, there is provided an analog input slave having an analog input portion and a network connecting portion, comprising: i) a sensing device for sensing at least one of a top and a valley of data acquired from the analog input portion; ii) a counting device for counting the number of the at least one of the top and the valley which are sensed with the sensing device; iii) a comparing device for comparing the number counted by the counting device with a threshold; and iv) a sending device for sending from the network connecting portion a comparison result by the comparing device.

The first aspect and the second aspect may be mounted alone. Otherwise, both of the first aspect and the second aspect may be mounted in one apparatus (slave) as described in the embodiment. The controller corresponds to a PLC 1, according to the embodiment. The total time calculating device, the sensing device, and the counting device each are realized by an operating portion 13a, according to the embodiment. The total time calculating device, specifically, corresponds to a processing step for incrementing the counter (1 count). Like this counter, the total time includes those specifying the time indirectly. In addition, a value (hereinafter referred to as “digital signal”) which is a conversion into digital data from analog data acquired from the input portion may be processed as is, or may be processed based on physical quantity data obtained by data conversion as according to the embodiment.

The latter case also seeks the acquired digital signal's top-valley or range indirectly, and therefore is included in the present invention. The comparing device corresponds to the threshold comparing portion 13d according to the embodiment. The device sending the comparison result to the network is realized by the status notifying portion 13f, the status control portion 15 and the like. The timing for sending the comparison result to network may be voluntary, or may be carried out based on the demand from the external portion. The analog data acquired from the input portion may be those used for controlling the FA, or those collected for monitor-maintenance and the like.

Based on each of the above inventions, the threshold can specify the replacement timing and maintenance timing of at least one of the analog device and the apparatus {control object (monitoring object)} in which the analog device is installed. In addition, under the present invention, the threshold is not necessarily be set to a value that corresponds to the replacement timing. Otherwise, the following setting is allowed: setting the threshold of a reference value showing the deterioration level and allowing the threshold to notify a certain deterioration level which is yet to reach the replacement timing. Preferably, the threshold is so set as to obtain information necessary for maintenance-control.

With this, on the upper side such as PLC, it is possible to recognize the state of the apparatus {control object (monitoring object)} on which the analog device and an analog device thereof are installed. Thereby, listing up devices and the like which are in need of replacement in the near future (although not in need of immediate replacement) and preparing in advance for replacement-maintenance (device-part sourcing, scheduling, and the like) are possible.

Under the present invention, the total time (within the range satisfying the condition on the slave side), the number of tops-valleys, and the like are sought based on the acquired digital signal, for comparison with the threshold. Thereby, on the upper side apparatus such as PLC, merely observing the comparison result can carry out the monitoring, eliminating the need of adding program for the above monitoring and the like to the apparatus on the upper side. In addition, controlling the object's temperature is not in need of implementing the above processing by the temperature regulator, eliminating unpreferable state such as the elongated control sense of the temperature regulation.

In addition, the outputting of the comparison result is so made as to be implemented when a predetermined state (for example, more than the threshold) is satisfied. Namely, the comparison result may be constantly sent. However, outputting only in a predetermined state (according to the embodiment, status ON) can suppress the comparison result from being frequently transmitted onto the network and suppress communication quantity by notifying as appropriate, thereby efficiently sending-receiving the data for controlling the FA by nature. In addition, the sought total time or the sought number may be outputted in combination with the comparison result or replacing the comparison result.

In addition, in the monitoring system under the present invention, each of the above slaves and the controller are connected by way of the network, and the above controller is so constituted as to acquire the comparison result of the slave.

Under the present invention, the slave acquiring the digital signal is so made as to seek the total time and the number of tops-valleys, thus eliminating the need of seeking each of the above pieces of information by the upper side apparatus such as PLC based on the analog data, suppressing the load on the upper side apparatus, and notifying the state such as whether or not it is the timing for replacing-maintaining the analog device and the device {control object (monitoring object)}. The other object(s) and feature(s) of the present invention will become understood from the following description with reference to the accompanying drawings.

### BRIEF DESCRIPTION OF THE DRAWINGS

FIG. 1 shows a monitoring system, according to an embodiment of the present invention.

FIG. 2 shows an explanation of input data transition relative to sensing condition.

FIG. 3 shows an example of a network system of a slave under the present invention.

FIG. 4 shows an internal structure of, mainly, an arithmetic operating portion 13.

FIG. 5 shows an explanation of hysteresis for seeking tops-valleys.

FIG. 6 shows an example of data structure of data operating instance which is stored in a non-volatile memory.

FIG. 7 shows an explanation of total time counting condition (temperature range).

FIG. 8 shows a flowchart of presetting-tuning for seeking tops-valleys.

FIG. 9 shows a flowchart of a processing function of seeking the number of tops-valleys.

FIG. 10 shows an explanation of an algorithm using hysteresis and determining tops-valleys.

FIG. 11 shows a flowchart of an internal processing of a function of seeking tops-valleys.

FIG. 12 shows a flowchart of a function of tuning and a function of reading out data.

FIG. 13 shows a flowchart of presetting-tuning for seeking total time count.

FIG. 14 shows a flowchart of a processing function of seeking total time count.

FIG. 15 shows a flowchart for explaining a specific processing algorithm of counting diversified by conditions (S54)

FIG. 16 shows a flowchart of an internal processing of a function of seeking total time count.

FIG. 17 shows a flowchart of a function of tuning and a function of reading out data.

### DESCRIPTION OF THE PREFERRED EMBODIMENTS

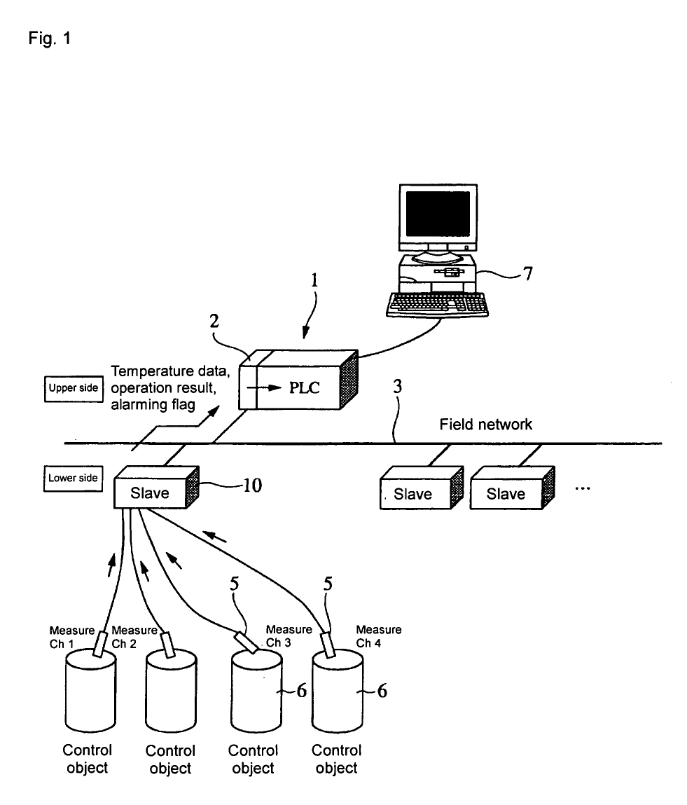

FIG. 1 shows an example of a network system to which the present invention is applied. In this example, a master unit 2 constituting a PLC 1 and a plurality of slaves 10 are connected to a field network 3. By way of the field network 3, the master unit 2 and the slaves 10 are mutually communicable. Category of the slaves 10 includes an IN slave taking in an input signal, an OUT slave outputting an output signal, a Mix slave for inputting and outputting, and the like. By way of the field network 3, the master unit 2 sends to a CPU unit a signal inputted from an input device connected to the IN slave 10. The CPU unit of the PLC 1 takes the thus given signal in an I/O memory, carries out a logic operation based on a user program which is built in a ladder language registered in advance, writes a result of implementing the logic operation in the I/O memory, and gives the result to the master unit 2. The master unit 2 sends an output signal to the OUT slave 10 byway of the field network 3, thereby implementing such a control as to drive and stop a control object. In addition, in terms of the present invention, the IN slave 10 is an analog input slave handling analog data, and four temperature sensors 5 are connected to the IN slave 10. The above four temperature sensors 5 measure temperatures of different control objects 6 respectively, sending the thus measured temperatures to the IN slave 10.

The analog input slave 10 according to the embodiment keeps the taken-in temperature data (digital signal) in an internal portion thereof, and counts i) top, ii) valley, and iii) time in a conditional temperature range. In addition, the analog input slave 10 notifies an upper position (the PLC 1 and the like) of the counting result only. Namely, an ordinary slave sends only an acquired digital signal to the PLC 1 (master unit 2), in this example, however, the digital signal is used for a certain arithmetic operation, sending information based on the arithmetic operation result. The digital signal is ordinarily not sent, however, may be so made as to be sent in the case of system's debugging, maintenance, and the like.

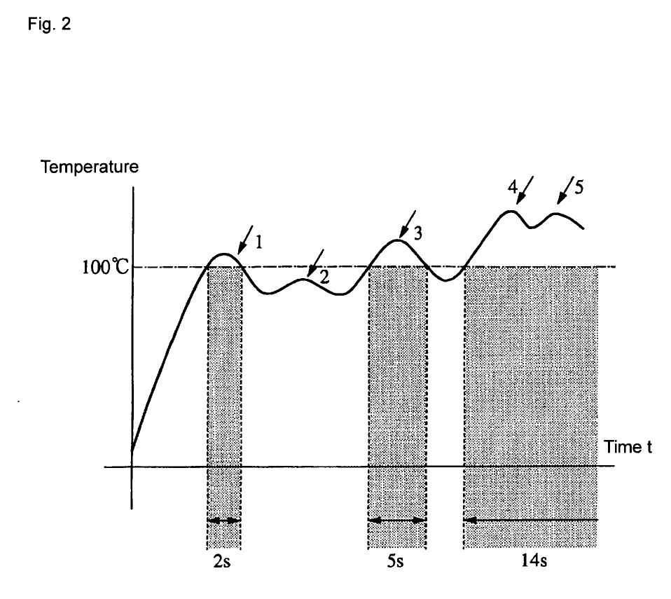

For example, a transition of the control object 6's temperature sensed with a certain temperature sensor 5 is depicted as shown in FIG. 2. In this case, an operation condition is so defined that, with more than 100° C., time measurement is to be implemented and the number of top value sensing caused by temperature change is to be counted. Then, according to the above example, a total time of more than 100° C. is 2+5+14=21 seconds, with the number of top sensing of 5. These values are sought and retained by the slave. In addition, each value has its threshold. A present value exceeding the threshold may be sent (notified) to the upper position as a status.

Moreover, an upper control computer 7 is connected to the PLC 1. The upper control computer 7 catches deterioration state and maintenance timing only by a notification result from the slave 10.

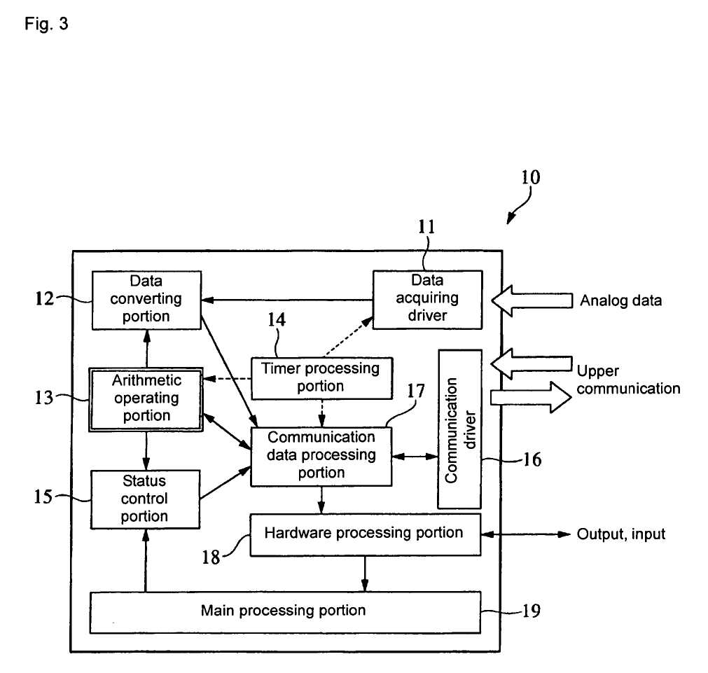

FIG. 3 shows a software block diagram of the slave 10. As obvious from FIG. 3, the slave 10 is provided with a data acquiring driver 11, a data converting portion 12, an arithmetic operating portion 13, a timer processing portion 14, a status control portion 15, a communication driver 16, a communication data processing portion 17, a hardware processing portion 18 and a main processing portion 19.

The data acquiring driver 11 acquires a digital signal which is digital data converted from analog data sent from a connected hardware, that is, the temperature sensor 5, and has a function of giving the digital data to the data converting portion 12. The data acquiring driver 11 starts based on an instruction from the internal timer processing portion 14.

The data converting portion 12 has a function of converting the acquired digital signal into physical quantity data which is shown to user. The thus converted and acquired data is given to the communication data processing portion 17. Namely, the digital signal acquired by way of the data acquiring driver 11 is, for example, an electric signal showing voltage and the like outputted from the temperature sensor 5, not a temperature value (“X” of X° C.). Therefore, the electric signal (for example, “10”) sent from the temperature sensor 5 is converted into a specific temperature (for example, “30° C.”). The above conversion may be carried out in the following manner: memorizing and keeping a conversion table associating the digital signal with the physical quantity data which is shown to user, and referring to the conversion table. Otherwise, the above conversion may be carried out the following manner: preparing a conversion formula and carrying out operation from time to time.

Based on the data obtained by being converted by the data converting portion 12, the arithmetic operating portion 13 implements various arithmetic operations, thus carrying out determination and other processes. The arithmetic operating portion 13 includes operation data, gives a processing result thereof and the like to the communication data processing portion 17, and outputs the processing result thereof and the like to an external portion (according to the embodiment, PLC and the like) Contrary to the above, the arithmetic operating portion 13, when receiving a notification such as operation condition change from an external portion (upper position) by way of the communication data processing portion 17, may make change according to the notification. Moreover, the arithmetic operating portion 13 may give to the status control portion 15 determination result such as an alarm which is outputted in the case of an over-threshold. Specific processing function of the arithmetic operating portion 13 is to be described afterward.

The timer processing portion 14 is provided with an internal timer, and based on the internal timer gives a starting instruction to the data acquiring driver 11, the arithmetic operating portion 13 and the communication data processing portion 17. In other words, the time processing portion 14 carries out timer control of each of the processing portions and the like, carrying out each processing periodically.

The status control portion 15 administers an entire state of software. For one example, the status control portion 15 receives abnormal information and other status which are also controlled by the arithmetic operating portion 13, the main processing portion 19 and the like, memorizing and keeping (control) them. In addition, the status control portion 15 gives to the communication data processing portion 17 the controlled status as status data, to thereby make the controlled status transferable to the upper PLC 1 and the like.

The communication driver 16 is a processing portion which has a communication with the upper device (the PLC 1 and the like) on the field network 3. To-be-sent data is generated at the communication data processing portion 17. In addition, the information received by way of the field network 3 is given to the arithmetic operating portion 13.

The communication data processing portion 17 controls i) a protocol which administers the field network 3, and ii) the communication data. The data controlled herein is processed as communication data. The outgoing data is sent upward. The data inputted from the external portion is outputted by the hardware processing portion 18. The communication data has i) a message communication for receiving events and the like from time to time and ii) an IO communication for constantly having communication.

The hardware processing portion 18 actually has an interface with the hardware, processing the output from the upper communication and reading in an external input (SW information of microcomputer, reading-writing of non-volatile memory, and the like).

The main processing portion 19 implements a main processing of the entire software. Specifically, the main processing portion 19 has functions of i) controlling the entire software state, and ii) notifying the status or stopping itself in the case of an abnormal state and the like as software.

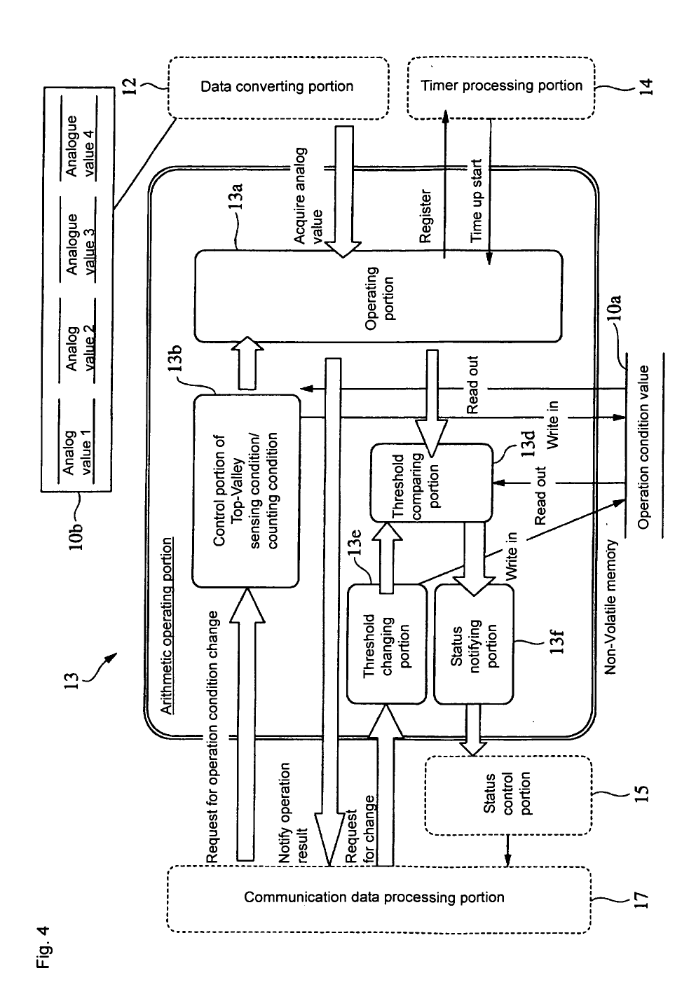

FIG. 4 is a more detailed functional block diagram of the arithmetic operating portion 13. The arithmetic operating portion 13 is provided with an operating portion 13a, a control portion 13b of top-valley sensing condition/counting condition, a threshold comparing portion 13d, a threshold changing portion 13e, and a status notifying portion 13f.

The control portion 13b of top-valley sensing condition/counting condition controls a method of sensing the top-valley, and controls conditions for counting up within a conditional temperature range. Specifically, in the example shown in FIG. 2, i) the number of tops and ii) the total time of periods causing more than or equal to 100° C. are sampled (arithmetic operation). In terms of the top-valley sensing, the control portion 13b of top-valley sensing condition/counting condition sets i) a method of sensing whether a sensed object is top, valley or both, and ii) a method of sampling as top (valley). In terms of the counting condition, the control portion 13b sets a to-be-counted object (more than or equal to what ° C.).

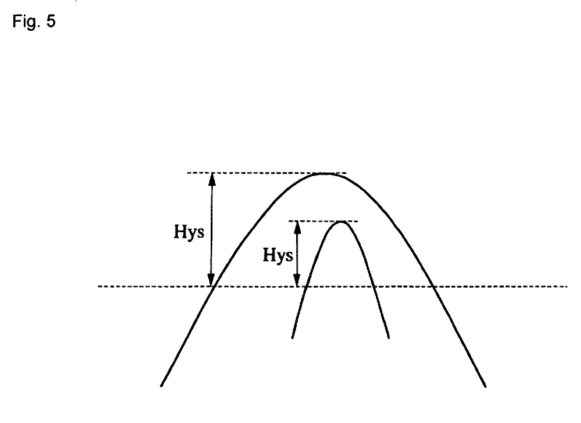

The sensing method of sensing the top-valley makes a comparison in a certain timing between the last but one value, the last value and the present value, and thereby senses when an amplitude having a certain value or more (depending on hysteresis value Hys) is observed. The hysteresis value Hys is for denoting what scale of top-valley is to be sensed. As shown in FIG. 5, the larger the hysteresis value Hys is, the less sharp the sensing of the top-valley is, while the smaller the hysteresis value is, the sharper the sensing of the top-valley is. In other words, for example, when a large hysteresis value Hys is set, a small fluctuation cannot be recognized as top-valley. Therefore, variably setting the hysteresis value makes it possible to achieve various uses of sensing according to application.

The above conditions are to be memorized and kept in a non-volatile memory 10a. Specifically, the control portion 13b of top-valley sensing condition/counting condition calls for conditions (sensing method of sensing top-valley, counting condition, and the like) stored in the non-volatile memory 10a in the inputting of power source and in other timing, and keeps them when the apparatus is operating. Then, in certain timing, the control portion 13b gives the kept conditions to the operating portion 13a. In addition, for example, with a conditional change received from the upper computer (the PLC 1) by way of the communication data processing portion 17, the control portion 13b renews the memorized-kept condition to the thus received change and stores the received condition in the non-volatile memory 10a, thus making the renewal. With this, whenever the power source is turned OFF, an updated operation method can be kept.

In addition, according to the embodiment, the control portion 13b of top-valley sensing condition/counting condition is one control portion that senses both of i) the sensing condition (sensing object and sensing method) about the top-valley, and ii) the counting condition. However, the control portion 13b may be so constituted as to have two different control portions for carrying out the above respective conditions.

From the control portion 13b of top-valley sensing condition/counting condition, the operating portion 13a acquires i) to-be-operated top-valley and ii) conditions about count. From the data converting portion 12, the operating portion 13a acquires corresponding data. Then, based on the acquired data, the operating portion 13a senses the top-valley, counts up within the conditional temperature range, and retains the result. In addition, the operation result is given to the threshold comparing portion 13d. Moreover, as appropriate, the operating portion 13a notifies the communication data processing portion 17 of the operation result, such as conformance to a predetermined condition. In addition, starting is implemented based on a starting instruction issued along with time up from the timer processing portion 14. Moreover, ending of the arithmetic operation is sent (notification, registration) to the timer processing portion 14. Data of an operation object, that is, each analog value stored in a volatile memory (RAM) 10b is acquired by way of the data converting portion 12.

The threshold comparing portion 13d reads out the threshold from the non-volatile memory 10a in advance, and makes a comparison between i) the operation result data sent from the operating portion 13a (the number of tops-valleys, and count time's present value) and ii) the threshold. Then, with the operation result data larger than the threshold, the threshold comparing portion 13d notifies the status notifying portion 13f. In addition, the threshold which is a reference for the comparison is set by the threshold changing portion 13e.

After receiving threshold change sent from the upper PLC 1, the control computer 7 and the like by way of the communication data processing portion 17, the threshold changing portion 13e notifies the threshold comparing portion 13d of the threshold change to thereby carry out changing of the threshold in operation, and carries out changing of the threshold on the non-volatile memory 10a. With this, the threshold changing portion 13e makes a control not to delete threshold data even after the power source is turned OFF.

After receiving notification of abnormal status from the threshold comparing portion 13d, the status notifying portion 13f notifies the external status control portion 15 of the abnormal status.

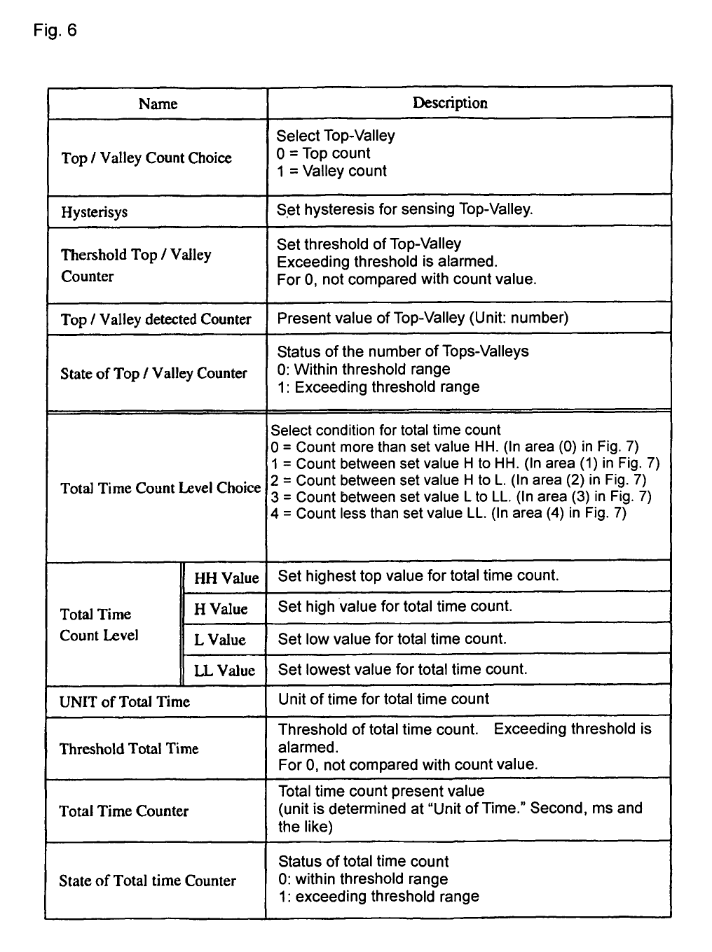

An operation parameter including information and the like controlled by the control portion 13b of top-valley sensing condition/counting condition can be memorized and controlled, for example, as an instance including a data structure shown in FIG. 6. The above instance is properly developed when necessary. For a plurality of object data, the instances are prepared in applicable number. FIG. 6 shows an example of an operation parameter corresponding to one operation object datum. For carrying out simultaneous operations on analog data from all four temperature sensors 5 like this embodiment, a total of 4 instances are necessary.

In FIG. 6, the object of the top-valley controlled by the control portion 13b of top-valley sensing condition/counting condition is controlled by “Top/Valley Count Choice”. In this example, the above object is set by selecting one of the top and the valley. As a manner of course, instead of the alternative selection, both of the top and the valley may be selected. Moreover, a hysteresis value for sensing top-valley which values controlled by the control portion 13b of top-valley sensing condition/counting condition is stored in the field “Hysteresis” for control.

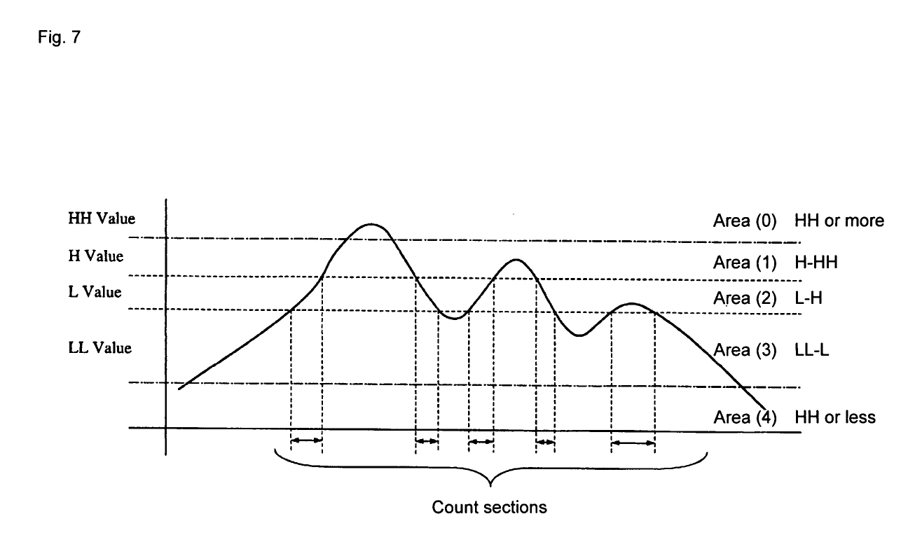

Moreover, the total time count's condition controlled by the control portion 13b of top-valley sensing condition/counting condition is controlled by the field “Total Time Count Level Choice”. Namely, of the areas designated by 0 to 4, which to count is selected by number. The areas designated herein are an area (0) to an area (4) shown in FIG. 7. In addition, values of respective lines “HH Value,” “H Value,” “L Value,” and “LL Value” are specified by being registered in “Total Time Count Level” of the instance. Moreover, unit (m second, second, minute, hour and the like) of time used for total time count is stored in “UNIT of Total Time”.

Herein, in the example in FIG. 6 and FIG. 7, the counting condition has 4 lines and 5 divisions. However, the dividing method is arbitrary. In addition, FIG. 7 shows a counting condition with the area (2) (Total Time Count Level Choice=2).

Moreover, the top/valley's present value which is an operation result at the operating portion 13a is stored in “Top/Valley detected Counter” of the instance. Herein, since the top/valley is alternatively selected, the field for storing the present value is one. However, fields for storing the top present value and the valley present value may be provided respectively. Likewise, the total time's present value is stored in “Total Time Counter”. Herein, the total time is to be accumulated in terms of any one of selected temperature ranges, therefore one total time's present value is stored. For seeking total time about a plurality of temperature ranges based on an output from one temperature sensor, setting a plurality of the above instances is allowed. As a matter of course, preparing a plurality of portions in advance as store area of the total time is allowed.

In addition, the threshold which is changed or set by means of the threshold changing portion 13e is stored in “Threshold Top/Valley Counter” (threshold of top-valley) and “Threshold Total time” (threshold of total time).

Then, in accordance with the threshold stored in “Threshold Top/Valley Counter” and “Threshold Total time” and in accordance with the present value stored in “Top/Valley detected Counter” and “Total Time Counter,” the threshold comparing portion 13d carries out threshold comparison with the operation result given from the operating portion 13a.

The state of the number of tops-valleys compared and sought by the threshold comparing portion 13d is stored in “State Of Top/Valley Counter” of the instance for control. The state of total time count compared and sought by the threshold comparing portion 13d is stored in “State Of Total Time Counter” of the instance for control.

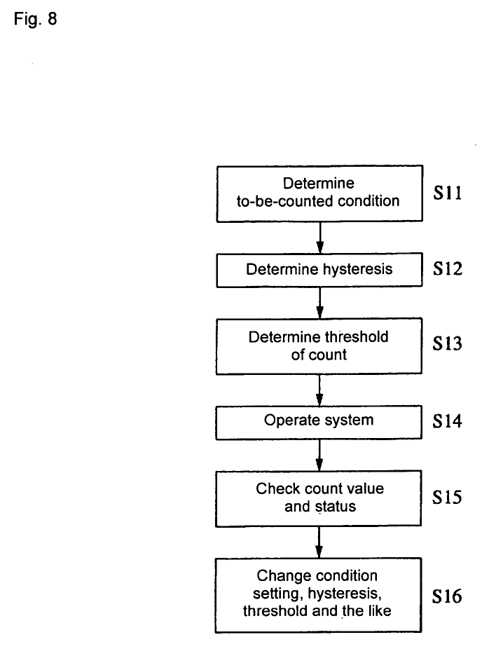

Hereinafter-described is explanation of an actual operation of the above-described apparatus (each processing portion and the like). FIG. 8 shows a flowchart for carrying out presetting-tuning for a function of making determination based on the total number of tops-valleys.

At first, which of top and valley to select for counting is determined (S11). For example, in a case that a temperature at one operation in a certain application temporarily becomes high and thereafter becomes low, and in proportion to the number of works this temperature change, as the case may be, deteriorates the apparatus, Top condition is to be selected. Implementing the processing step S11 can determine items of “Top/Valley Count Choice” of the instance shown in FIG. 6.

Then, a hysteresis for sampling as top/valley which is set in S11 is determined (S12). Specifically, of those for setting sensing sensitivity of Top/Valley; for taking a smooth (not sharp) sensitivity, the hysteresis is to be set large, and for taking a rapid (sharp) sensitivity, the hysteresis is to be set small. This hysteresis is for setting with analog value, and thereby is determined by tuning. For example, in the following case, the hysteresis is to be set large by tuning: Although measurement of the number of Tops at temperature change per operation is desired, a temporary swing of Top value is caused in the vicinity of Top, resulting in sensing of five Top values per operation. The hysteresis is to be set large by tuning, so as to sense (measure) one Top per operation. Implementing this processing step S12 can determine the item “hysteresis” of the instance shown in FIG. 6.

Then, a threshold of the count value is to be set (S13). Herein set is a threshold of the number to be alarmed, for example, for alarming the Top values more than 10,000, the threshold is to be set as “10,000”. Implementing the processing step S13 can determine the item “Threshold Top/Valley Counter” of the instance shown in FIG. 6.

Thereafter, the system is to be operated (S14), and in certain timing the operation result and the status are to be checked (S15). This apparatus is so constituted that the following i) and ii) are constantly referable: i) the above operation results, “(Top/Valley Counter: present value being counted)” and ii) “(State of Top/Valley Counter: threshold is exceeded or not)” which specifies whether or not the threshold is exceeded (presence-absence of abnormal status). In addition, as appropriate, data on the operation object, and the threshold are to be changed (S16). Resetting the counter is also allowed.

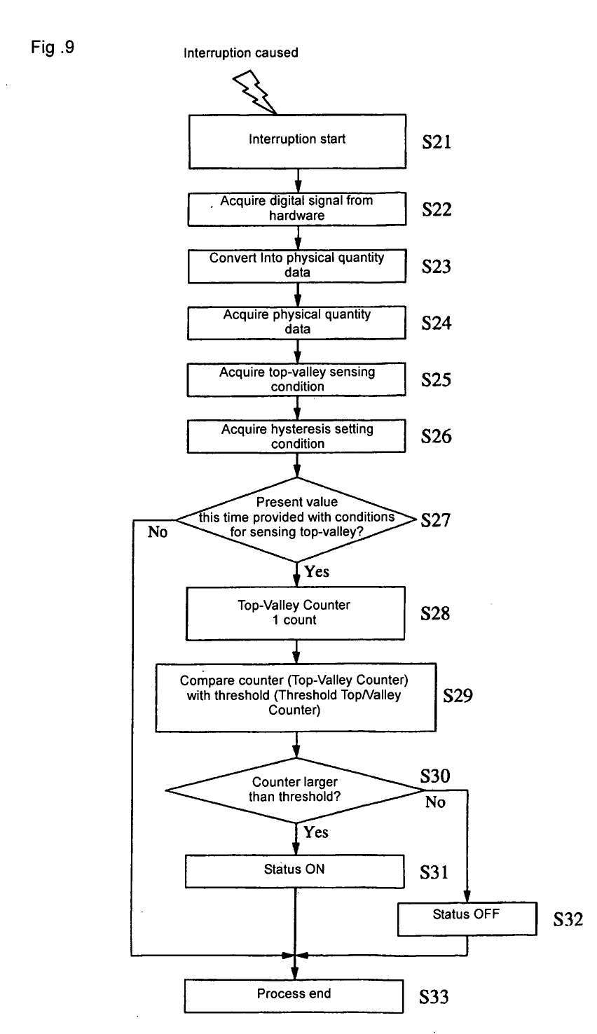

FIG. 9 shows a specific algorithm of top-valley counting (including data converting). According to this embodiment, digital signal acquisition, physical quantity data conversion, top-valley counting is carried out based on an interruption (S21). This interruption can be realized by several methods, examples thereof including: i) starting with an external hardware interruption, ii) a timer interruption based on the timer processing portion 14 {a method of starting data processing by recognizing that analog/digital conversion (hereinafter referred to as “A/D conversion”) is ended at time up of a certain timer}, iii) sensing of A/D conversion end flag (a method of starting data processing, after checking an end of A/D conversion by periodical flag checks), and the like.

Then, the digital signal is acquired from the hardware (the temperature sensor 5) by way of the data acquiring driver 11, to be given to the data converting portion 12 (S22). The data converting portion 12 converts the thus acquired digital signal into physical quantity data which is understandable by user (S23), then the thus converted physical quantity data is given to the arithmetic operating portion 13 (S24).

From the control portion 13b of top-valley sensing condition/counting condition, the arithmetic operating portion 13 acquires sensing condition of top-valley, that is, information about whether the sensing object is top or valley (S25), and acquires hysteresis setting condition (S26). Then, the arithmetic operating portion 13 determines whether or not the present value (acquired in S24) acquired this time is provided with conditions for sensing top/valley, in other words, whether or not the present value is top (valley) (S27).

The sensing by the hysteresis determines an upward tendency when the digital signal's present value acquired this time is larger than a hysteresis setting width with respect to a reference value, thereby carrying out top sensing process from the next value acquisition. The top sensing process determines a downward tendency when the analog signal's present value acquired this time is smaller than the hysteresis setting width after the top sensing, and determines the top when the analog signal's present value acquired this time is smaller than the hysteresis setting value after starting of the top sensing process. Herein, the valley sensing is carried out oppositely.

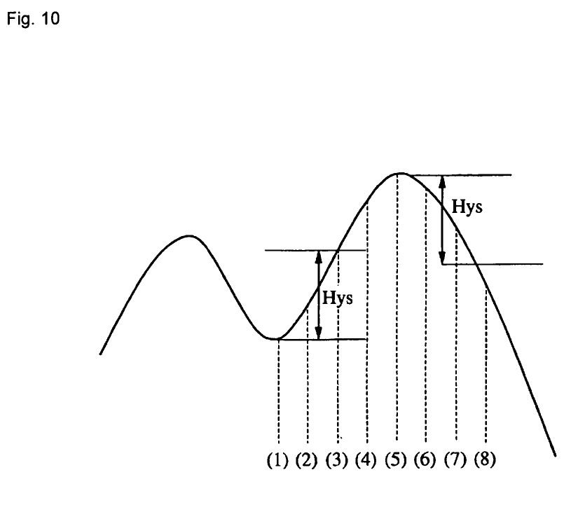

An explanation is made of the reference value and a determining process based thereon, referring to the transition of digital signal, as shown in FIG. 10. In this example, a timer start acquires the present value per certain interval, making determination. Specifically, measurement is to be started from (1), causing the reference value. Then, comparing the present value at (2) with the reference value (1) causes a change that, is less than the hysteresis value Hys, which is determined not to be the upward tendency. Thereby, the reference value remains the value at (1). Then, comparing the present value at (3) with the reference value (1) causes a change that is the hysteresis value Hys or more, which is determined to be the upward tendency. Thereby, the reference value is set to the present value at (3).

The present value acquired at (4) is more increased than the reference value (3), keeping the upward tendency. Thereby, without the top sensing, the reference value is switched from (3) to (4). Likewise, the present value acquired at (5) keeps the upward tendency. Thereby, without the top sensing, the reference value is switched from (4) to (5).

Then, the present value acquired at (6) starts to get smaller than the reference value (5), which is determined to be the downward tendency. The change is, however, less than the hysteresis value Hys, therefore, the processing is skipped there, waiting for acquisition of the next present value. As a result, the reference value remains the value at (5). Likewise, (7) shows the downward tendency. The change is, however, less than the hysteresis value Hys, therefore the reference value remains the value at (5). Then, the present value acquired at (8) causes a change width more than or equal to the hysteresis {with respect to the reference value (5)} for the first time since the start of the downward tendency, therefore sensing the top there, ending the top sensing process this time. Herein, the reference value is to be changed to the present value at (8).

When the present value acquired in S24 this time according to the above sensing algorithm is not the top/valley, the processing along with the present value this time is ended, therefore waiting for the next interruption. On the other hand, when the present value acquired this time is determined to be the top/valley, Top/Valley Counter counts one (increment) (S28). This counter value (total number of tops/valleys) is to be kept by the operating portion 13a, and to be given to the threshold comparing portion 13d at the next stage.

Then, the threshold comparing portion 13d reads out the threshold stored in the non-volatile memory 10a and compares the counter value (sought at the operating portion 13a through the implementation of S28) with the threshold (S29), thereby determining whether or not the counter value operation result is larger than the threshold (S30). Then, the result of branching determination of S30 showing that the counter value is larger than the threshold turns ON the status (S31), while smaller than the threshold turns OFF the status (S32). The above ON/OFF of the status is stored in the non-volatile memory 10a.

Storing the status, as described above, ends a series of processes for one operation. The internal process flow shown in FIG. 9 is in terms of one arithmetic operation. For plural operations, the next arithmetic operation 2 is to be started after the end of the arithmetic operation 1, to thereby carry out like processes.

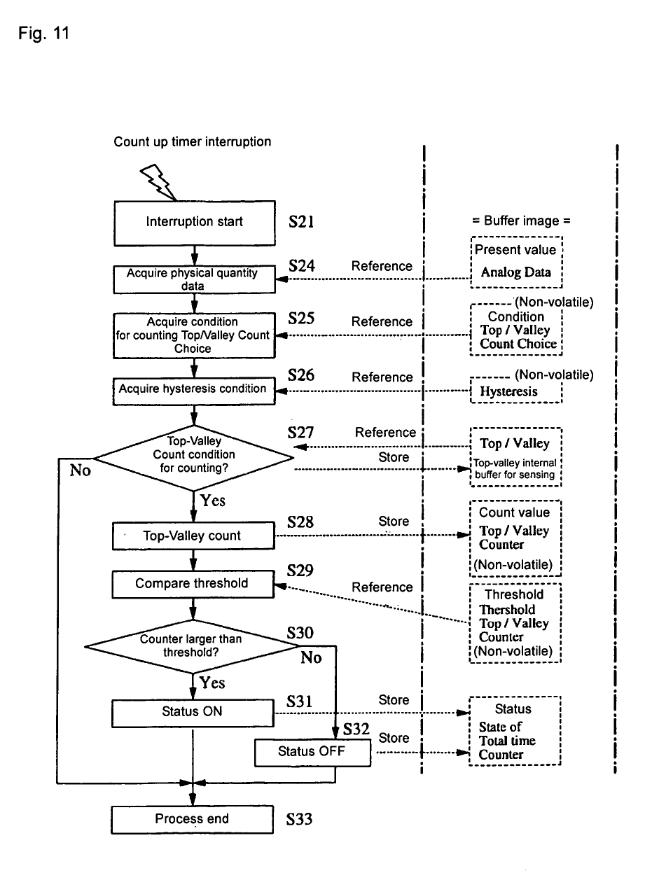

In addition, of the process flow shown in FIG. 9, especially, the internal process of the arithmetic operating portion 13 becomes the one in FIG. 11, showing, in combination, data's reading-writing to a non-volatile memory-buffer in the case that each processing step is implemented.

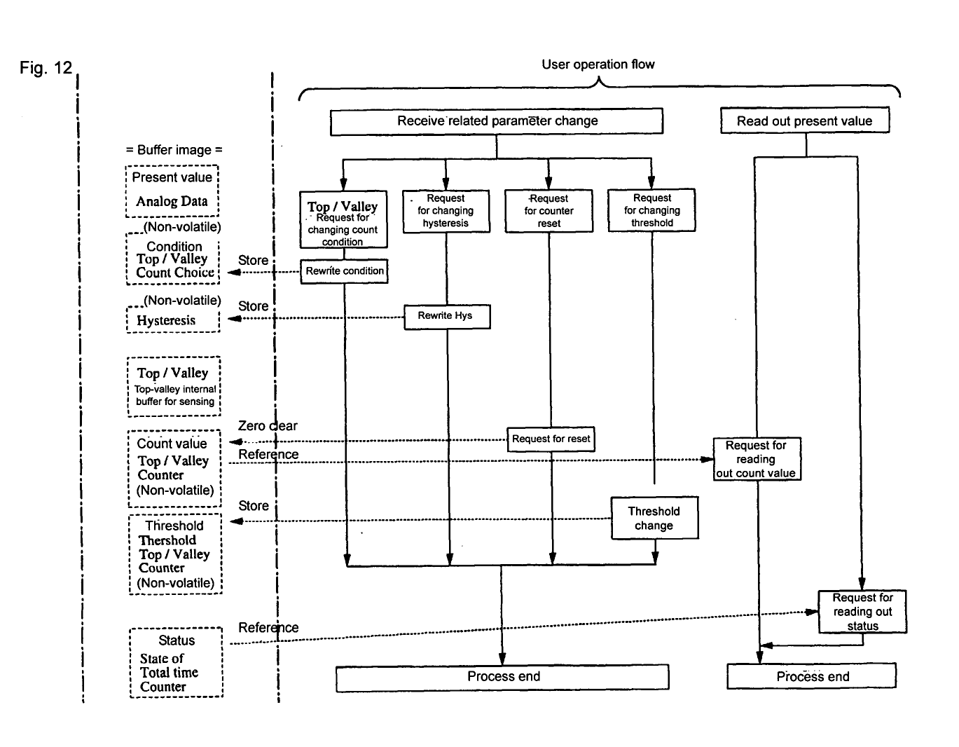

Specific processes in S15 and S16 in FIG. 8 are carried out by the flow shown in FIG. 12. Specifically, in the checking step of checking the count value and the status in S15, as shown in FIG. 12, a user (external portion) gives a present value read-out instruction. Then, at least one of the count value and the status is designated as a read-out object, which is to be read out from the non-volatile memory 10a and then outputted.

On the other hand, the changing step of changing the condition and the threshold in S16, as shown in FIG. 12, receives a request for changing a related parameter (a change request given by way of the communication data processing portion 17 in FIG. 4), recognizes the thus received object (counting condition, hysteresis, counter reset, and threshold), and rewrites changed data in corresponding memory areas of the non-volatile memory 10a. Although not shown, according to the change, information retained by the control portion 13b of top-valley sensing condition/counting condition and by the threshold changing portion 13e is also to be renewed.

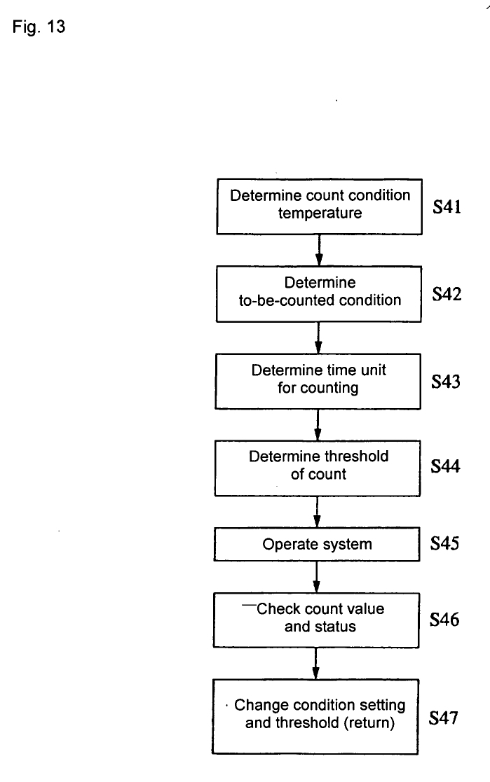

Hereinafter explained is about the total time processing. FIG. 13 shows a flowchart for carrying out presetting-tuning for the function of making determination based on the total time of the period provided with conditions.

At first, to-be-counted conditions are to be determined (S41). Specifically, determined at first is a temperature range within which the time counting is started, by setting the following parameters:
time count of a certain temperature or over,
time count of a certain temperature or below, and
time count in a range of a first certain temperature to a second certain temperature.

According to the embodiment, four patterns of thresholds are prepared (HH, H, L, and LL) which are set, for example, in the following manner:

| | | | |
|---|---|---|---|
| HH: 1,000° C., | H: 800° C., | L: 500° C., | LL: 200° C. |

Herein, any unnecessary parameter for the condition may be eliminated from the setting. Implementing the processing step S41 may determine each of the items “HH Value, H Value, L Value, and LL Value” of “Total Time Count Level” of the instance shown in FIG. 6.

Then, the to-be-counted condition is determined (S42). Specifically, in the above set temperature range, any of the following is to be set:

| | |
|---|---|
| count at HH or more | set “0” |
| count between H and HH | set “1” |
| count between L and H | set “2” |
| count between LL and L | set “3” |
| count at LL or less | set “4” |

For example, “2” is to be selected for counting in the inputting in a range of 500° C. to 800° C., and “4” is to be selected for counting in the inputting at 200° C. or less. Implementing this processing step in S42 can determine the item “Total Time Count Level Choice” of the instance shown in FIG. 6. Herein, the temperature ranges set by the above designation each includes the boundary point (specifically, in a range from A or more to B or less), however, any one of the boundary may be eliminated (specifically, in a range from A or more to less than B).

Then, the time unit for the counting is determined (S43), specifically, setting a time unit such as “second”. Implementing the processing step in S43 can determine the item “UNIT of Total Time” of the instance shown in FIG. 6.

Then, the threshold of the count value is set (S44). Herein set is the threshold of a result to be alarmed, for example, for alarming the total time in the set range over 50,000 seconds, the threshold is to be set to “50,000”. Implementing this processing step in S44 can determine the item “Threshold Total Time” of the instance shown in FIG. 6.

Thereafter, the system is to be operated (S45), to thereby check the count value (total time) and the status in a certain timing (S46). This apparatus is so constituted that the following i) and ii) are constantly referable: i) operation results, “Total Time Counter” and ii) “State of Total Time Counter” which specifies whether or not the threshold is exceeded (presence-absence of abnormal status). In addition, as appropriate, designation address specifying data on the operation object, and the threshold are to be changed (S47).

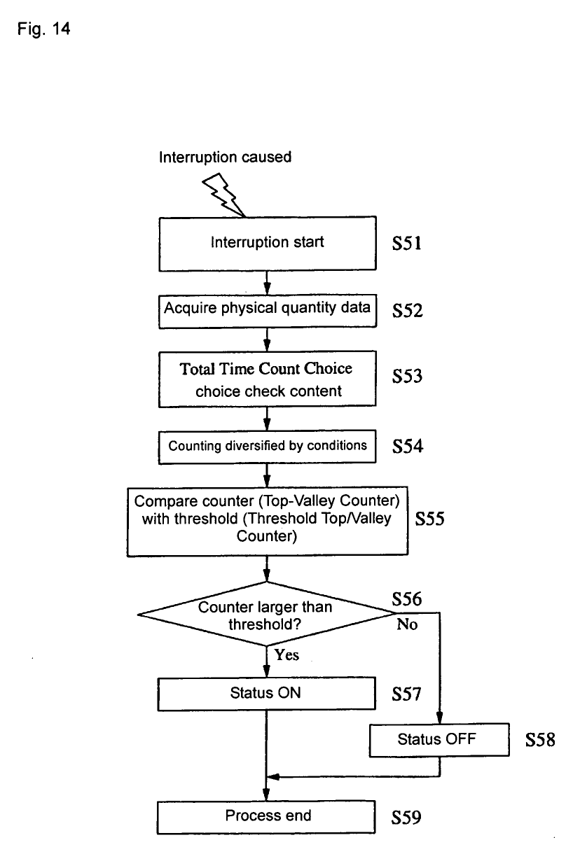

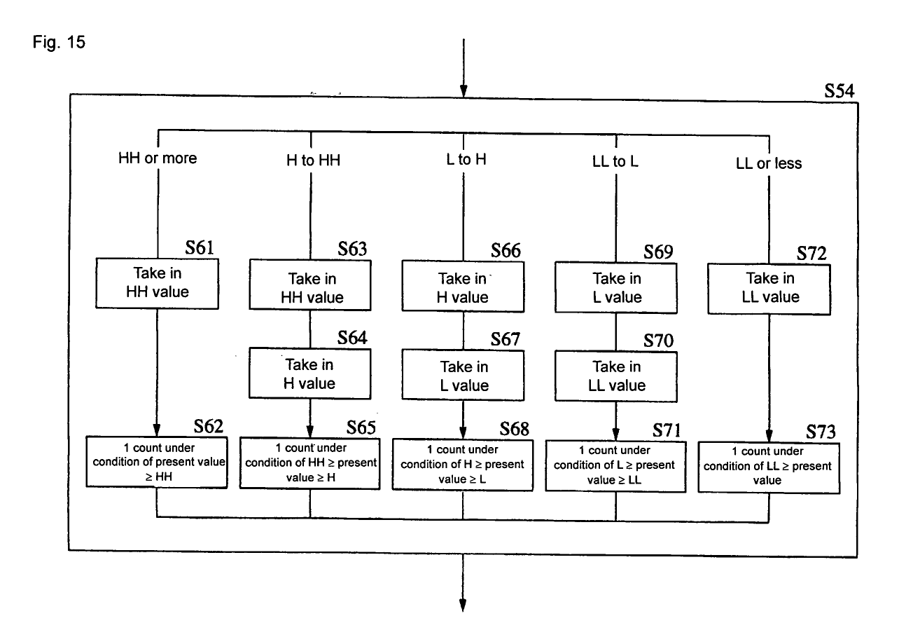

FIG. 14 and FIG. 15 each show a specific algorithm of total time counting. According to this embodiment, the total time counting is carried out based on the interruption (S51). The interruption is the same as that in S21 in the top-valley counting.

Then, the present value of the digital signal (temperature) is acquired (S52). Specifically, the analog data is acquired from the hardware (the temperature sensor 5) by way of the data acquiring driver 11, after A/D conversion, the analog data is given to the data converting portion 12, the data converting portion 12 converts the acquired digital signal into the physical quantity data understandable by the user, then, the arithmetic operating portion 13 acquires the thus converted data.

From the control portion 13b of top-valley sensing condition/counting condition, the arithmetic operating portion 13 acquires the counting condition of total time, that is, the temperature range condition for counting the total time (S53). In addition, according to the present value (value acquired in S52) this time, the arithmetic operating portion 13 carries out counting diversified by conditions (S54).

Specifically, as shown in FIG. 15, with the temperature range condition of HH or more, HH Value of the instance in FIG. 6 is taken in (S61), and with the present value of HH Value or more, Total Time Counter of the instance in FIG. 6 is increased by one (count up) (S62). So setting that the interrupting of S51 is caused by the timer and the like in a certain time interval can seek the total time, by the thus counted value multiplied by the certain time interval. As a manner of course, an after-described threshold is also set based on this counter value. Therefore, the algorithm seeking the status is not in need of converting into the total time which is easily recognized by human, herein, the processing is carried out based on the count value.

In addition, with the temperature range condition in a range from H to HH, the HH Value and the H Value of the instance in FIG. 6 are take in (S63, S64), and with the present value in a range of H Value to HH Value, Total Time Counter of the instance in FIG. 6 is increased by one (count up) (S65). Likewise, afterward, the boundary value specifying the temperature range condition is acquired from an applicable portion of Total Time Count Level of the instance, thereby determining whether or not the present value is within the temperature range, when within, increasing the counter by one (increment) (S66 to S73). Then, the counter value (total time) of the Total Time Counter is kept by the operating portion 13a, stored in the instance of the non-volatile memory 10a, and then is given to the threshold comparing portion 13d at the next stage.

Then, the threshold comparing portion 13d reads out the threshold stored in the non-volatile memory 10a, compares the counter value (sought in the operating portion 13a by implementing the counting diversified by conditions in S54) with the threshold (S55), to thereby determine whether or not the counter value is larger than the threshold (S56). Then, with the branching determination result by S56 showing that the counter value is larger than the threshold, the status is turned ON (S57), smaller than the threshold, the status is turned OFF (S58). The above turning ON/OFF of the status is also stored in the non-volatile memory 10a.

With the above storing of the status, a series of processes of one operation are ended. Each of the process flows shown in FIG. 14 and FIG. 15 is for one operation. For a plurality of flows, the next arithmetic operation 2 is to be started after the end of the arithmetic operation 1, to thereby carry out like processes.

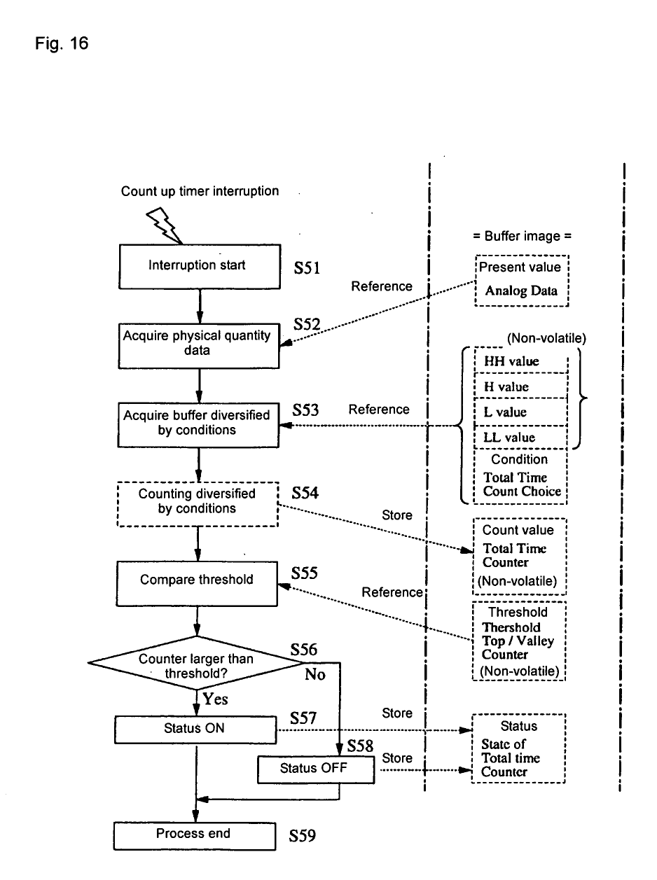

In addition, of the process flows shown in FIG. 14 and FIG. 15, especially, the internal process of the arithmetic operating portion 13 becomes the one in FIG. 16, showing, in combination, data's reading-writing to a non-volatile memory-buffer in the case that each processing step is implemented.

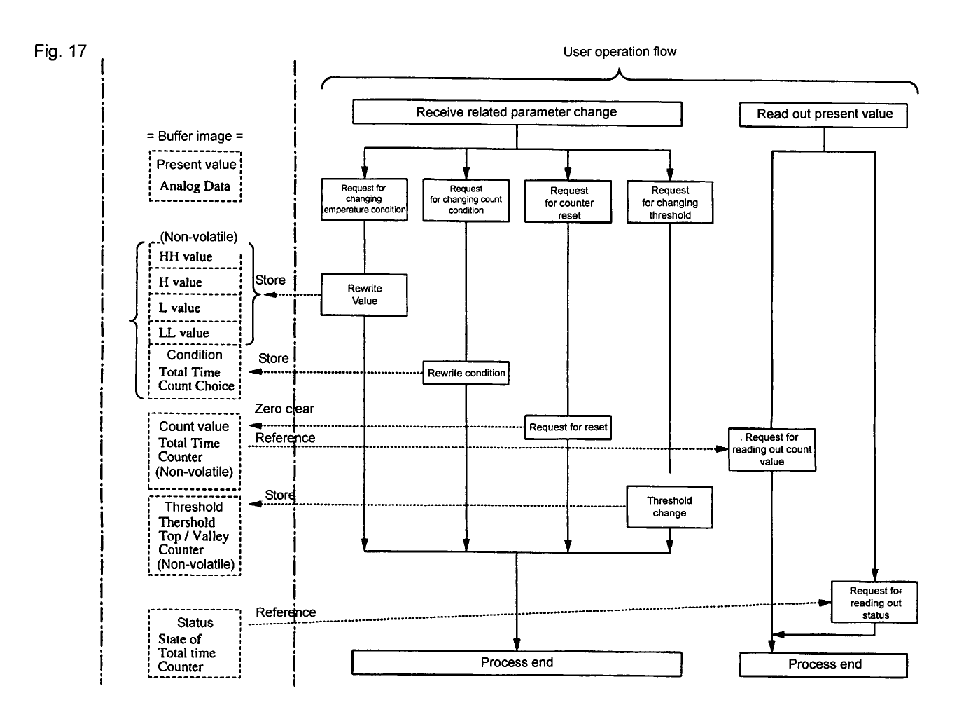

Specific processes of S46 and S47 in FIG. 13 are carried out by the flow shown in FIG. 17. Specifically, in the checking step of checking the count value and the status in S46, as shown in FIG. 17, the user (external portion) gives a present value read-out instruction. Then, at least one of the count value and the status is designated as the read-out object, which is to be read out from the non-volatile memory 10a the designated object and then outputted.

On the other hand, the changing step of changing the condition and the threshold in S47, as shown in FIG. 17, receives a request for changing the related parameter (a change request given by way of the communication data processing portion 17 in FIG. 4), recognizes the thus received object (conditional temperature, counting condition, counter reset, and threshold), and rewrites the changed data in the corresponding memory areas of the non-volatile memory 10a. Although not shown, according to the change, the information retained by the control portion 13b of top-valley sensing condition/counting condition and by the threshold changing portion 13e is also to be renewed.

According to any of the above embodiments, the temperature sensor is used as the analog device, and the analog data is temperature. The present invention is, however, not limited to this, frequency and other types of analog data (those changeable with abnormality and the like) may also be used.

The scope of the present invention is defined with reference to the following claims.

1. An analog input slave having an analog input portion and a network connecting portion, comprising:
i) a total time calculating means for seeking a total time when data acquired from the analog input portion is within a set range;
ii) a comparing means for comparing the total time sought by the total time calculating means with a threshold; and
iii) a sending means for sending from the network connecting portion a comparison result by the comparing means.

2. The analog input slave as claimed in claim 1, wherein the threshold specifies at least one of a replacement timing and a maintenance timing of at least one of the following:
a device connected to the analog input portion, and
a monitoring object to which the device is connected.

3. The analog input slave as claimed in claim 1, wherein the comparison result is sent to a network when the total time exceeds the threshold.

4. A monitoring system, comprising:
the analog input slave according to claim 1; and
a controller connected to the analog input slave by way of a network,
wherein the controller acquires the comparison result of the analog input slave.

5. An analog input slave having an analog input portion and a network connecting portion, comprising:
i) a sensing means for sensing at least one of a top and a valley of data acquired from the analog input portion;
ii) a counting means for counting the number of the at least one of the tops and the valley which are sensed with the sensing means;
iii) a comparing means for comparing the number counted by the counting means with a threshold; and
iv) a sending means for sending from the network connecting portion a comparison result by the comparing means.

6. The analog input slave as claimed in claim 5, wherein the threshold specifies at least one of a replacement timing and a maintenance timing of at least one of the following:
a device connected to the analog input portion, and
a monitoring object to which the device is connected.

7. The analog input slave as claimed in claim 5, wherein the comparison result is sent to a network when the number exceeds the threshold.

8. A monitoring system, comprising:
the analog input slave according to claim 5; and
a controller connected to the analog input slave by way of a network,
wherein the controller acquires the comparison result of the analog input slave.
